(19) United States
(12) Patent Application Publication
(10) Pub. No.: US 2015/0228992 A1
(43) Pub. Date: Aug. 13, 2015

(54) METHOD FOR GENERATING EXTRA POWER ON FUEL CELL POWER GENERATION SYSTEM IN USING OXYGEN ENRICHED GAS INSTEAD OF AIR

(71) Applicant: YUAN ZE UNIVERSITY, Taoyuan County (TW)

(72) Inventors: GUO-BIN JUNG, TAOYUAN COUNTY (TW); TING-CHU JAO, TAOYUAN COUNTY (TW); SHIH-HUNG CHAN, TAOYUAN COUNTY (TW); WEI-JEN TZENG, TAOYUAN COUNTY (TW); YU-HSU LIU, HSINCHU COUNTY (TW)

(21) Appl. No.: 14/679,751

(22) Filed: Apr. 6, 2015

Related U.S. Application Data
(63) Continuation-in-part of application No. 13/726,136, filed on Dec. 23, 2012, now abandoned.

(30) Foreign Application Priority Data
Sep. 12, 2012 (TW) 101133324

(51) Int. Cl. H01M 8/06; H01M 8/18; H01M 8/04

(52) U.S. Cl. CPC H01M 8/0662; H01M 8/0687; H01M 8/0656; H01M 8/0618; H01M 8/04201; H01M 8/186

(57) ABSTRACT

A method for generating extra power on fuel cell power generation system in using oxygen enriched gas is disclosed. A first fuel cell power generation system is provided, having a fuel cell device, an oxygen separator, a hydrogen generation apparatus and an air compressor connected to the oxygen separator, and a second fuel cell power generation system is provided having the fuel cell device, the hydrogen generation apparatus and the air compressor connected to the oxygen separator. The method includes: introducing the hydrogen generated by the hydrogen generation apparatus for the anode of the fuel cell device, and introducing the compressed air generated by the air compressor and oxygen enriched gas generated by oxygen separator for the cathode of the fuel cell device respectively, to generate electrical power. The extra power is defined by:

$$Z = \frac{K \times G \times V \times ( 5 \times E \times F - 1 ) - X}{K \times G \times V - Y} \times 100 \%$$

where Z is proportional to a fuel cell number of the fuel cell device.

### CROSS-REFERENCE TO RELATED PATENT APPLICATION

This application is a continuation-in-part of U.S. patent application Ser. No. 13/726,136, filed Dec. 23, 2012, entitled “FUEL CELL POWER GENERATION SYSTEM WITH OXYGEN INLET INSTEAD OF AIR,” by Guo-Bin Jung, Ting-Chu Jao, Shih-Hung Chan, Wei-Jen Tzeng and Yu-Hsu Liu, which itself claims priority to and the benefit of Taiwan Patent Application No. 101133324, filed Sep. 12, 2012. The disclosures of the above identified applications are incorporated herein in their entireties by reference.

Some references, which may include patents, patent applications and various publications, are cited and discussed in the description of this invention. The citation and/or discussion of such references is provided merely to clarify the description of the instant disclosure and is not an admission that any such reference is “prior art” to the invention described herein. All references cited and discussed in this specification are incorporated herein by reference in their entireties and to the same extent as if each reference was individually incorporated by reference.

### FIELD

The instant disclosure generally relates to a fuel cell power generation system, and more particularly to a method for generating extra power on a fuel cell power generation system using oxygen enriched gas instead of air.

### BACKGROUND

A fuel cell is a high efficient and clean power source. The fuel cell may directly convert the chemical energy of various fuels, such as alcohol, natural gas or hydrogen, to the electrical power by reduction and oxidation (also referred to as “redox”) reactions. The fuel cell becomes a burgeoning and popular power generating device, because it has the characteristics of the high energy conversion efficiency and the low environmental pollution. The hydrogen-oxygen fuel cell utilizes hydrogen and oxygen as the fuel and oxidant, and the only by-product generated is just water. The hydrogen-oxygen fuel cell usually has a proton exchange membrane (PEM) as the electrolyte, so it is also called a proton exchange membrane fuel cell.

Referring to FIG. 1, FIG. 1 is a schematic diagram of a conventional proton exchange membrane fuel cell. The proton exchange membrane fuel cell 1 comprises an anode 11, a cathode 12 and a proton exchange membrane 14. A load 13 is connected to the anode 11 and the cathode 12 in order to constitute a closed loop circuit. Hydrogen (H₂) may generate electrons through the oxidation reaction at the anode 11, and the generated electrons are transferred to the cathode 12 through the load 13. The cathode 12 utilizes the oxygen in the air and the electrons received by the closed loop circuit to perform the reduction reaction. Although the fuel cell has been widely used, the production of new fuel cells and the associated power generation system is still an important subject for the skilled in the art.

Therefore, heretofore unaddressed needs still exist in the art to address the aforementioned deficiencies and inadequacies.

### SUMMARY

One aspect of the instant disclosure is directed to a method for generating extra power on fuel cell power generation system in using oxygen enriched gas instead of air. In certain embodiments, the method includes:

coupling an oxygen separator to a cathode of a fuel cell device, and a hydrogen generation apparatus to an anode of the fuel cell device respectively, to form a first fuel cell power generation system, wherein the first fuel cell power generation system comprises the fuel cell device, the oxygen separator, the hydrogen generation apparatus and an air compressor connected to the oxygen separator;

generating hydrogen by the hydrogen generation apparatus;

generating compressed air by the air compressor, and sending the compressed air to the oxygen separator;

generating oxygen enriched gas by the oxygen separator from the compressed air received from the air compressor;

introducing the oxygen enriched gas generated by the oxygen separator into the cathode of the fuel cell device, and introducing the hydrogen generated by the hydrogen generation apparatus into the anode of the fuel cell device, to generate electrical power from the fuel cell device; and

powering the oxygen separator and the air compressor using a portion of the electrical power generated from the fuel cell device;

wherein the first fuel cell power generation system is configured to generate extra power comparing to a second fuel cell power generation system operated under same conditions as the first fuel cell power generation system without using the oxygen separator, the second fuel cell power generation system comprising the fuel cell device, the hydrogen generation apparatus and the air compressor coupled directly to the cathode of the fuel cell device, and using the hydrogen generated by the hydrogen generation apparatus and the compressed air generated by the air compressor for the anode and the cathode of the fuel cell device respectively to generate electrical power;

wherein the extra power is defined by a formula as follows:

$$Z = \frac{K \times G \times V \times ( 5 \times E \times F - 1 ) - X}{K \times G \times V - Y} \times 100 \%$$

where:

Z is a net extra power ratio of a net electrical power output difference between the first fuel cell power generation system and the second fuel cell power generation system to a second net electrical power output by the second fuel cell power generation system, wherein the net electrical power output difference is a difference between a first net electrical power output by the first fuel cell power generation system and the second net electrical power output by the second fuel cell power generation system;

K is a characteristic factor of the electrical power generated by categories of the fuel cell device of the first fuel cell power generation system and the second fuel cell power generation system, respectively;

E is a required volume of the oxygen enriched gas generated by the oxygen separator of the first fuel cell power generation system;

F is a performance increase factor of using the required volume of the oxygen enriched gas in the fuel cell device of the first fuel cell power generation system;

G is a required volume of air by the air compressor of the first fuel cell power generation system, and by the air compressor of the second fuel cell power generation system, respectively;

V is an operating voltage by the fuel cell device of the first fuel cell power generation system, and by the fuel cell device of the second fuel cell power generation system, respectively;

X is the portion of the electrical power generated by the fuel cell device used by the oxygen separator of the first fuel cell power generation system; and

Y is the portion of the electrical power used by the air compressor of the first fuel cell power generation system, and by the air compressor of the second fuel cell power generation system;

wherein Z is proportional to a fuel cell number of the fuel cell device in a series connection.

In certain embodiments, all of the electrical power consumed by the oxygen separator and the air compressor of the first fuel cell power generation system are provided by the electrical power generated by the fuel cell device of the first fuel cell power generation system. In certain embodiments, Z is greater than 20%.

In certain embodiments, the fuel cell device and the hydrogen generation apparatus are implemented by a reversible fuel cell device. In certain embodiments, the reversible fuel cell device is configured to operate in a first mode or a second mode, where:

when the reversible fuel cell device operates in the first mode, the reversible fuel cell device receives electrical power to electrolyze water for generating the hydrogen, and

when the reversible fuel cell device operates in the second mode, the reversible fuel cell device utilizes the hydrogen generated in the first mode and the oxygen enriched gas generated by the oxygen separator to generate the electrical power.

In certain embodiments, when the reversible fuel cell device operates in the first mode, the hydrogen generated is stored in a hydrogen storing unit.

In certain embodiments, when the reversible fuel cell device operates in the second mode, the reversible fuel cell device utilizes the hydrogen from the hydrogen storing unit to generate the electrical power.

To sum up, a method for extra power receiving on fuel cell power generation system with oxygen enriched gas inlet instead of air, utilizes the oxygen generated by the oxygen separator to replace the air, and the output electrical power of the fuel cell can be effectively enhanced. Meanwhile, the enhanced output electrical power to provide power required of each device is discovered and calculated, thus the efficiency of the overall power generation of the fuel cell generation system can be improved, cause to cost-effective operation has opportunity used in industrial application.

These and other aspects of the instant disclosure will become apparent from the following description of the preferred embodiment taken in conjunction with the following drawings and their captions, although variations and modifications therein may be affected without departing from the spirit and scope of the novel concepts of the disclosure.

### BRIEF DESCRIPTION OF THE DRAWINGS

The accompanying drawings illustrate one or more embodiments of the disclosure and, together with the written description, serve to explain the principles of the disclosure. Wherever possible, the same reference numbers are used throughout the drawings to refer to the same or like elements of an embodiment, and wherein:

FIG. 1 shows a schematic diagram of a conventional proton exchange membrane fuel cell.

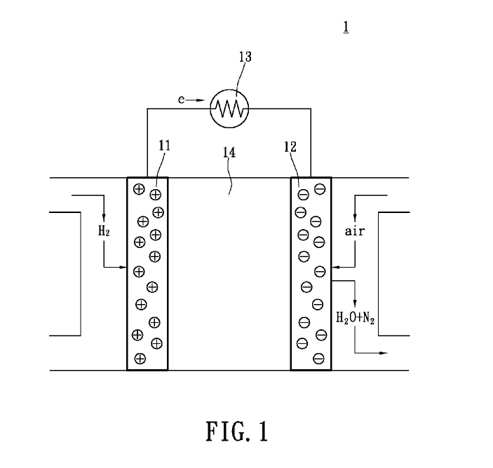

FIG. 2A shows a block diagram of a second fuel cell power generation system without oxygen separator according to an embodiment of the instant disclosure.

FIG. 2B shows a block diagram of generating extra power on a first fuel cell power generation system within oxygen separator according to an embodiment of the instant disclosure.

FIG. 3A shows a detailed block diagram of a fuel cell power generation system according to an embodiment of the instant disclosure.

FIG. 3B shows an experimental curve diagram of voltage versus current density of the fuel cell device according to an embodiment of the instant disclosure.

FIG. 4 shows a block diagram of a fuel cell power generation system according to another embodiment of the instant disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, “plurality” means two or more.

As used herein, the terms “comprising,” “including,” “carrying,” “having,” “containing,” “involving,” and the like are to be understood to be open-ended, i.e., to mean including but not limited to.

The present disclosure will now be described more fully hereinafter with reference to the accompanying drawings, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout.

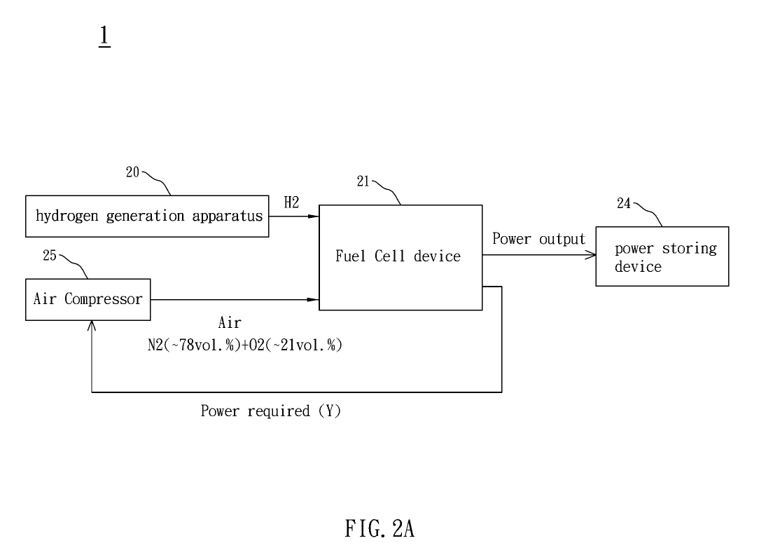

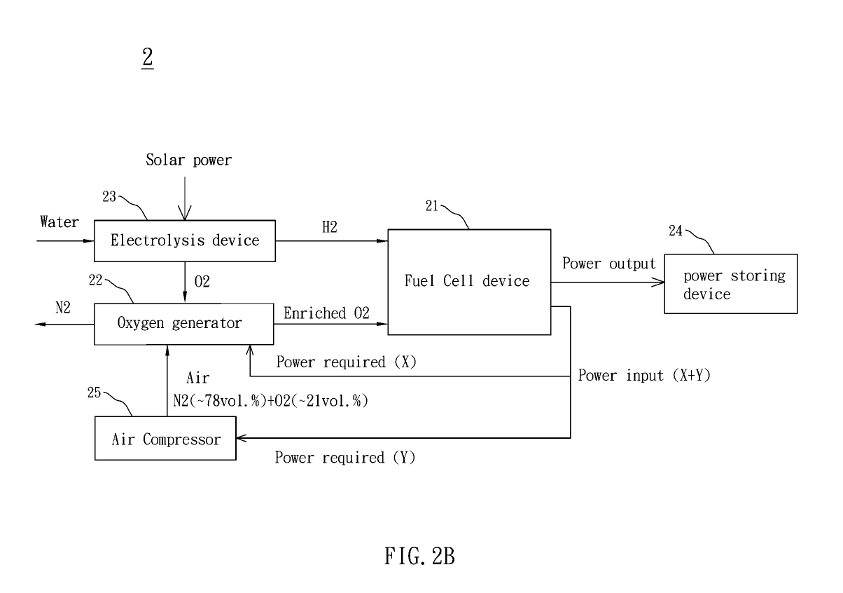

Referring to FIG. 2A, FIG. 2A shows a block diagram of a second fuel cell power generation system without oxygen separator according to an embodiment of the instant disclosure. Specifically, the second fuel cell power generation system 1 is provided for comparison with a first fuel cell power generation system (details of which will be elaborated later) using oxygen enriched gas instead of air. As shown in FIG. 2A, the second fuel cell power generation system 1 substantially at least comprises a fuel cell device 21 coupled to a hydrogen generation apparatus 20 and an air compressor 25 respectively. The fuel cell device 21 is operated by introducing air (˜78 vol. % N₂, ˜21 vol. % O₂ and ˜1 vol. % other gases) from the air compressor 25, and hydrogen from the hydrogen generation apparatus 20 respectively into a cathode and an anode of the fuel cell device 21, to process electrochemical reaction to generate electric power. In certain embodiments, any part of the electric power generated may be provided to power the air compressor 25, power other electrical devices, or use as power saved by a power storing device 24, or any combination thereof. However, the procedure does not conforms to the economic efficiency in the long-term that cost from power required (Y) of the air compressor 25, hydrogen (H₂) production from hydrogen generation apparatus 20, and low-efficiency in utilizing air as oxidant source.

One aspect of the instant disclosure relates to a method for generating extra power on the fuel cell power generation system in using oxygen enriched gas instead of air. In certain embodiments, a first fuel cell power generation system 2 is provided for utilizing the oxygen enriched gas to replace the air, and utilizing the oxygen enriched gas to as the oxidant source when the fuel cell device 21 is generating electric power. In the following paragraphs of the instant disclosure, improved power generation efficiency could be carried out when using oxygen enriched gas to be the oxidant source for the fuel cell device. The power consumption for the oxygen separator to generate oxygen enriched gas is less than the increased power output of the fuel cell device. Therefore, the overall power generation efficiency of the fuel cell power generation system could be improved.

Referring to FIG. 2B, FIG. 2B shows a block diagram of the first fuel cell power generation system according to an embodiment of the instant disclosure. The first fuel cell power generation system 2 shown in FIG. 2B merely introduces the inventive concepts of the instant disclosure, and the subsequent embodiment and the drawings will further disclosure the detailed elements of the fuel cell generation system. The first fuel cell power generation system 2 comprises an oxygen separator 22 connected to the air compressor 25, the air compressor 25, the hydrogen generation apparatus 20, and the fuel cell device 21. The fuel cell device 21 is coupled to the oxygen separator 22 and an electrolysis device 23 respectively. In certain embodiments, the hydrogen generation apparatus 23 can be selected from an electrolysis device 23, a reformer (not shown in FIG. 2B), a hydrogen storage tank (not shown in FIG. 2B), or any combination thereof. As shown in FIG. 2B, the electrolysis device 23 is provided as the hydrogen generation apparatus 23 by utilizing solar power to generate hydrogen in this embodiment.

The oxygen separator 22 is provided mainly to generate oxygen enriched air (OEA, O₂ purity about ˜25 to ˜100 vol. %) in air separated process from air (˜78 vol. % N₂, ˜21 vol. % O₂ and ˜1 vol. % other gas) input by the air compressor 25, and in used in numerous chemical, medical and industrial application, in substance, this instant disclosure discloses plurality of air separated processes (process of physics or chemical) as below.

The oxygen separator 22 utilizes adsorption gas separation technology as an adsorption gas apparatus (e.g. pressure swing adsorption PSA, vacuum swing adsorption VSA, hybrid vacuum-pressure swing adsorption-VPSA, or temperature-pressure swing adsorption TPSA), membrane gas separation technology, or cryogenic gas separation technology. Adsorption principle of adsorption gas separation technology is based on adhesion of various gas mixture components to a solid substance called adsorbent, physically, this phenomenon is brought about by the forces of gas and adsorbent molecules interaction, and in the pressure swing adsorption flow processes, oxygen is recovered under above-atmospheric pressure and regeneration is achieved under atmospheric pressure. In vacuum swing adsorption flow processes, oxygen is recovered under atmospheric pressure and regeneration is achieved under negative pressure, and in the mixed, the operation combination pressure variations from positive to negative, wherein oxygen enriched air production (O₂ purity is about 91˜95 vol. %).

However, in cryogenic air separation, ambient air is compressed before being purified, afterwards, pressurized air is cooled near its dew point in the main heat exchanger by distillation products and fed in the high pressure column, and air distillation takes place in both columns and the products are recovered slightly above atmospheric pressure after being reheated in the main heat exchanger, therefore the pressure at the end of the compression train is function of the required oxygen purity, wherein oxygen enriched air production (O₂ purity is about 95 to ˜100 vol. %).

In contrast, a membrane separation apparatus (including polymeric membrane and ceramic membrane) that operation principle of polymeric membrane is based on gas media separation with the use of membrane is the difference in velocity with which various gas mixture components permeate membrane substance, the driving force behind the gas separation process is the difference pressures on different membrane sides, in which oxygen enriched air production (O₂ purity is about 25 to 45 vol. %) is used. Therefore, the oxygen enriched air production by air separation technology as above is considered to being a different application, but otherwise the ceramic membrane is known as Ion transport membrane (ITM) that is based on produce oxygen by the passage of oxygen ions through the ceramic crystal structure. These systems operate at high temperatures, generally over 1100° F. Oxygen molecules are converted to oxygen ions at the surface of the membrane and transported through the membrane by an applied electric voltage or oxygen partial pressure difference, then reform oxygen molecules after passing through the membrane material (O₂ purity is about ˜100 vol. %). Further, membrane materials can be fabricated into flat sheets or tubes for different industrial application.

Moreover, chemical process is based on absorption of oxygen by a circulating molten salt stream followed by desorption through a combination of heat and pressure reduction of the salt stream, Air is compressed from 20 to 185 psia and treated to remove water and carbon dioxide in an adsorbent-based system. Water and carbon dioxide would both degrade the salt if not removed at this stage. Air flows through an adsorbent bed until bed saturation is reached. The beds are switched and the saturated bed is regenerated by dry nitrogen from the process. The clean, dry air is heated against returning product streams to between 900° F. and 1200° F. in the main heat exchangers. The hot air flows to the bottom of the absorber where it contacts molten liquid salt. The oxygen in the air reacts chemically with the salt and is removed with the liquid salt leaving the bottom of the absorber. The oxygen-bearing salt is heat interchanged with oxygen-free salt and further heated before being reduced in pressure and flowing to the desorber. Gaseous oxygen leaves the top of the desorber, while oxygen-lean salt is removed from the bottom of the desorber, heat interchanged and sent to the top of the absorber vessel to close the loop, wherein the oxygen enriched air production (O₂ purity is about ˜100 vol. %).

In a preferred embodiment, the inventors disclose the power generation system 2, which comprises the oxygen separator 22 that generates the oxygen enriched gas and has an oxygen storing unit to store the generated oxygen enriched gas. The electrolysis device 23 in using solar power to electrolyze the water to generates hydrogen and has a hydrogen storing unit to store the generated hydrogen.

The fuel cell device 21 is connected to the oxygen separator 22 and the electrolysis device 23. In certain embodiments, the fuel cell device 24 makes the reaction of the oxygen generated by the oxygen separator 22 and the hydrogen generated by the electrolysis device 23 to generate electrical power, besides of utilizing the electrolysis device 23 electrolyze water to generate hydrogen, also utilize the reformer instead of electrolysis catalyze hydrocarbon species (ex. methanol, natural gas, . . . ) to generate required hydrogen, or provided from hydrogen storage tank.

The fuel cell device 21 may utilize the proton exchange membrane (PEM) fuel cell to make reaction of hydrogen and oxygen for generating electrical power. The fuel cell device 21 may be different in types. For example, the fuel cell device 21 may utilize proton exchange membrane fuel cell, direct methanol fuel cell, alkaline fuel cell, phosphoric acid fuel cell, carbonate molten salt fuel cell, solid oxide fuel cell, or any combination thereof. As long as the fuel cell device 21 could generate electrical power, the electrolysis device 23 is not restricted thereto. The electrolysis device 23 may be different in types. For example, the electrolysis device 23 may utilize proton exchange membrane water electrolysis, alkaline electrolysis, phosphoric acid electrolysis, carbonate molten salt electrolysis, solid oxide electrolysis, or any combination thereof. As long as the electrolysis device 23 could generate hydrogen.

In one embodiment, for conforming to the economic efficiency in the long-term, and many times of simulation and experiment, the method for generating extra power on the fuel cell power generation system 2 comprises:

coupling the cathode of the fuel cell device 21 to an oxygen separator 22, and the hydrogen generation apparatus 20 to the anode of the fuel cell device 21 respectively, to form the first fuel cell power generation system 2, and the air compressor 25 connected to the oxygen separator 22;

generating hydrogen by the hydrogen generation apparatus 20, and introducing the hydrogen for the anode of the fuel cell device 21 of the first fuel cell power generation system 2, and generating compressed air by the air compressor, and sending the compressed air to the oxygen separator 22;

generating oxygen enriched gas by the oxygen separator 22 from the compressed air received from the air compressor 25, and introducing the oxygen enriched gas generated by the oxygen separator 22 into the cathode of the fuel cell device 21 to generate electrical power from the fuel cell device 21 and powering the oxygen separator 22 and the air compressor 25 using a portion of the electrical power generated from the fuel cell device, wherein the net electrical power output by the first fuel cell power generation system 2 is configured to generate extra power comparing to the net electrical power output by the second fuel cell power generation system 1.

In certain embodiments, the first fuel cell power generation system is operated by introducing oxygen enriched gas (25 vol. % to ˜100 vol. % O₂) and hydrogen from the oxygen separator 22 and the electrolysis device 23 respectively into the cathode and the anode of the fuel cell device 21, and generating at least a portion of electrical power from the fuel cell device 21 to power the oxygen separator 22 and the air compressor 25. In certain embodiments, all of the electrical power consumed by the oxygen separator 22 and the air compressor 25 of the first fuel cell power generation system are provided by the electrical power generated by the fuel cell device of the first fuel cell power generation system. The extra power having cost-effective operation is calculated by complex relationship by unit of time from electrical power consume, electrochemical reaction, and electrical power output of each device as such different fuel cell power generation system (systems 1 and 2). For example, the inventors used PEMFC to describe the calculation between the fuel cell power generation systems 1 and 2. In the system 1 show as FIG. 2A, the fuel cell device 21 (for a single fuel cell) produces 1 A/cm² of current density (I/cm2) at least needs 3.5 c.c. O₂ (2 times is better, 7 c.c.). Therefore, 1 c.c of O₂ from the oxygen separator 22 may generate a second net electrical power output (Woutput−Wconsume), which is equal to ((˜21% O₂×G×V)/7 c.c)−Y=0.0286GV−Y.

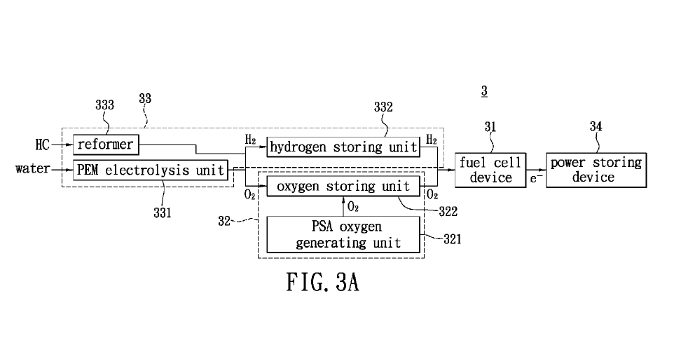

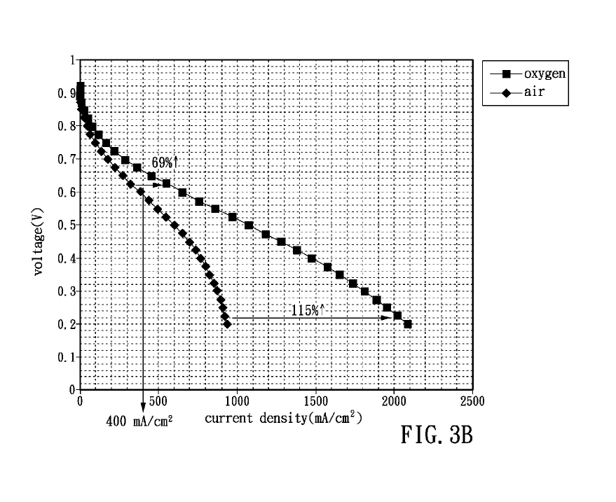

Under the same condition of operating of the system 2 show as FIG. 2B (producing 1 A/cm² of electrical current), due to higher O₂ purity (%) being fed in (approximate 5 times O₂ purity), the system may perform higher electrochemical reaction (higher current density generated refer to FIG. 3B). Therefore, 1 c.c of O₂ from the oxygen separator 22 may generate a first net electrical power output, which is equal to ((˜100% O₂×E×F×V)/7 c.c)−X−Y=(0.143×E×F×V)−X−Y, so as to generate the extra power of the fuel cell power generation system 2, which is defined by a formula as follows:

$$Z = \frac{0.0286 \times G \times V \times ( 5 \times E \times F - 1 ) - X}{0.0286 \times G \times V - Y} \times 100 \%$$

where Z is a net extra power ratio of a net electrical power output difference between the first fuel cell power generation system 2 and the second fuel cell power generation system 1 to a second net electrical power output by the second fuel cell power generation system 1, and the net electrical power output difference is a difference between a first net electrical power output by the first fuel cell power generation system 2 and the second net electrical power output by the second fuel cell power generation system 1, E is a required volume of the oxygen enriched gas generated by the oxygen separator of the first fuel cell power generation system 2, F is a performance increase factor of using the required volume of the oxygen enriched gas in the fuel cell device of the first fuel cell power generation system 2, G is a required volume of air by the air compressor of the first fuel cell power generation system, and by the air compressor of the second fuel cell power generation system, respectively, V is an operating voltage by the fuel cell device of the first fuel cell power generation system, and by the fuel cell device of the second fuel cell power generation system, respectively, X is the portion of the electrical power generated by the first fuel cell device used by the oxygen separator of the first fuel cell power generation system, and Y is the portion of the electrical power used by the air compressor of the first fuel cell power generation system 2, and by the air compressor of the second fuel cell power generation system 1. In certain embodiments, Z is proportional to a fuel cell number of the first fuel cell device in a series connection.

Corresponding to the above, the current density of fuel cell device 21 generated is depend on the categories of fuel cell utilized (different current density generated in condition of the same fuel gas in different fuel cell). Therefore, the extra power of the fuel cell power generation system 2 is defined by a modified formula as follows:

$$Z = \frac{K \times G \times V \times ( 5 \times E \times F - 1 ) - X}{K \times G \times V - Y} \times 100 \%$$

where K is a characteristic factor of electrical power generated by the categories of the fuel cell device 21.

Certain aspects of the instant disclosure are directed to a PSA oxygen generator as oxygen separator 22, which utilized in the pressure swing adsorption technique to extract the oxygen in the air for obtaining high concentration of oxygen. Basically, the pressure swing adsorption technique is a gas separation technology, in which an adsorbent (e.g. porous solid material) is used usually. The inner surface of the adsorbent is used to make physical adsorption for the gas molecules, thus the different gas molecules could be separated. The physical adsorption usually includes cycling process with pressurized adsorption and vacuum adsorption. One embodiment of the pressure swing adsorption is use molecular sieve (e.g. Zeolite molecular sieve (ZMS) or Lithium molecular sieve) to adsorb nitrogen of the air, meanwhile, the amount of oxygen in the air adsorbed to the molecular sieve is quite less. Thus, the proportion of the nitrogen in the air is significantly reduced, and the proportion of the oxygen in the air is greatly increased. Accordingly, the high concentration oxygen could be made. Additionally, the adsorbent may be recycled by using atmospheric desorption or vacuum pumping. The PSA oxygen generator may utilize pressurized adsorption (in which the pressure varies from 0.2 MPa to 0.6 MPa) and atmospheric pressure desorption, thus the cost of the machine is less, the process is more simple, and adapted for the PSA oxygen generator occasions of small-scale. For the PSA oxygen generator occasions of large-scale, the PSA oxygen generator may utilize atmospheric pressure adsorption (or with pressure a little larger than atmospheric pressure (less than 50 KPa)) and vacuum desorption, meanwhile, the machine is more complicated and the efficiency is higher and the power consumption per generating unit is less. However, the above-mentioned examples is only for conveniently explaining the principle of the PSA oxygen generator, the instant disclosure does not limited the generating oxygen method of the exemplary embodiment of the PSA oxygen generator and other exemplary embodiments of the PSA oxygen generator.

Referring to FIG. 2B and FIG. 3A, FIG. 3A shows a detailed block diagram of a fuel cell power generation system according to an embodiment of the instant disclosure. The fuel cell power generation system 3 comprises a pressure swing adsorption (PSA) oxygen generator 32, a hydrogen device 33, a fuel cell device 31 and a power storage device 34. The pressure swing adsorption (PSA) oxygen generator 32 has a pressure swing adsorption (PSA) oxygen generation unit 321 and an oxygen storing unit 322. The hydrogen device 33 has a proton exchange membrane electrolysis unit 331 or a reformer 333 and a hydrogen storing unit 332. The fuel cell device 31 can be a proton exchange membrane fuel cell, a direct methanol fuel cell, an alkaline fuel cell, a phosphoric acid fuel cell, a carbonate molten salt fuel cell, a solid oxide fuel cell, or any combination thereof.

The fuel cell device 31 connected to the PSA oxygen generator 32 and the hydrogen device 33, the fuel cell device 31 is used for making the reaction of the oxygen generated by the PSA oxygen generator 32 and the hydrogen generated by the hydrogen device 33 to generate electrical power. The proton exchange membrane electrolysis unit 331 or reformer 333 of the hydrogen device 33 is used to produce hydrogen, and the hydrogen storing unit 332 is for storing hydrogen. The pressure swing adsorption (PSA) oxygen generation unit 321 of the PSA oxygen generator 32 is used to produce oxygen enriched gas, and the oxygen storing unit 322 is used to store the oxygen enriched gas generated by the pressure swing adsorption (PSA) oxygen generation unit 321.

The proton exchange membrane (PEM) electrolysis unit 331 electrolyzes water to generate the hydrogen (H₂) and oxygen (O₂), and then the generated hydrogen (H₂) and oxygen (O₂) is transmitted to the hydrogen storing unit 332 and the oxygen storing unit 322 respectively. Conventionally, the oxygen generated by electrolyzing water will be discharged into the air; the generated oxygen does not used for other purposes, but the embodiment of the instant disclosure can keep the oxygen generated by electrolyzing water, so that the subsequent reaction can obtain more pure oxygen source. However, the pressure swing adsorption (PSA) oxygen generation unit 321 of the PSA oxygen generator 32 can obtains a large number of oxygen from the air; therefore, the instant disclosure does not limited whether the oxygen generated by the proton exchange membrane electrolysis unit 331 is stored to the oxygen storing unit 322 or not, for subsequent purposes.

Referring to FIG. 3B, FIG. 3B shows an experimental curve diagram of voltage versus current density of the fuel cell device according to an embodiment of the instant disclosure. When the oxidant source of the cathode of the fuel cell device 31 is obtained by replacing the air (which contains approximately 20% oxygen) into pure oxygen, the output current of the fuel cell device 31 can be obviously enhanced. For example, when the output voltage is 0.6 volts, the output current generated by supplying pure oxygen to the cathode than by supplying air to the cathode was increased by 63%. When the output voltage is 0.2 volts, the output current generated by supplying pure oxygen to the cathode than by supplying air to the cathode was increased by 115%, it is reasonably predicted that the output current will be increased if the oxygen concentration of inlet oxidant source is enriched (25˜100 vol. %), to indicate that defined F (factor) has correct interpretation as its value is proportional to O₂ purity, and higher O₂ purity lead to higher value of F Basically, minimum of F is more than 1, and maximum is achieved to 5 or higher (independent on O₂ purity). Please refer to the following descriptions for the detailed calculations about enhancing the power generation efficiency.

The following calculations is based on the situation by taking the oxygen generated from the PSA oxygen generator 32 as the oxidant source of the fuel cell device 31, when the fuel cell device 31 generates electrical power. To further understand the instant disclosure, the fuel cell device with 10 kilo-watt (kW) output power uses air and hydrogen as the oxidant and fuel source to operate for one minute is taken to illustrate and understand the calculation mechanism how to operate. Please assume that the fuel cell device is composed of 100 fuel cells (cell area=416 cm²) in series and each of fuel cells can generate 0.6 volts. At this time, the output current (density) of the fuel cell device is: 10,000 W/100 cells/0.6V=166.67 A=400 mA/cm²×416 cm². If the oxidant gas supplied for the cathode is exchanged to oxygen from air, the same stack of the fuel cell can generate 16.3 kW power (10 kW*(1+63%)). At this time, the output current of the fuel cell device is 271.67 amps (166.67×1.63). Theoretically, when each of fuel cells produced 1 A/cm² current density per minute, 3.5 c.c. would be consumed, it means that oxygen consumption is 3.5 cc/min. Therefore, the required volume of oxygen for the fuel cell device operating one minute can be calculated as follows:

$$271.67 A \times \frac{3.6 cc}{1 min . \times 1 cell \times A} \times 100 cell \times \frac{1 {m}^{3}}{1000000 cc} \times 1 min . = 0.095 {m}^{3}$$

From the above-mentioned procedures, the required volume of oxygen for the fuel cell device operating one minute is 0.095 m³. However, in practical applications, the required volume of oxygen for the fuel cell device may be the two times of the theoretical value. Therefore, the required volume of oxygen could be estimated to 0.19 m³ (0.095*2). According to the above descriptions, an extra 6.3 kW (16.3 kW−10 kW) power can be obtained by using pure oxygen (relative to air) to operate the above-mentioned reactions.

Additionally, when the pressure swing adsorption (PSA) oxygen generation unit 321 generates oxygen, each volume of one cubic meter oxygen (or called pure oxygen) needs to consume 318 watts of power. In other words, in order to manufacture one cubic meter oxygen, the pressure swing adsorption (PSA) oxygen generation unit 321 needs to consume 0.318 kilowatts power, it means 0.318 kW/m³. According to the above calculations about the desired amount of oxygen, in order to manufacturer 0.19 m³ oxygen needs to consume 0.06 kW power (0.06 kW=0.19 m³*0.318 kW/m³). Subtract the electrical power for generating oxygen from the electrical power generated by the fuel cell device, and the total power of the net increase is 6.24 kW (6.3 kW−0.06 kW=6.24 kW). Therefore, it has a profit to use the pressure swing adsorption oxygen generation method to produce pure oxygen to supply for the fuel cell.

In other words, when pure oxygen is used as the oxidant source of the cathode of the fuel cell during the reaction of oxygen molecules (oxidant), the output power of the fuel cell can be effectively enhanced. After subtracting the electrical power consumed by the PSA oxygen generator from the increased output power generated by the fuel cell, the fuel cell still gets extra electrical power.

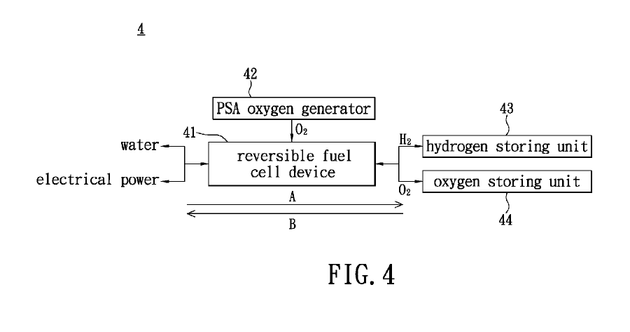

Referring to FIG. 4, FIG. 4 shows a block diagram of a reversible fuel cell power generation system according to another embodiment of the instant disclosure. The reversible fuel cell power generation system 4 or the electrical storing system 4 comprises a pressure swing adsorption (PSA) oxygen generator 42, a hydrogen storing unit 43, an oxygen storing unit 44 and a reversible fuel cell device 41. The reversible fuel cell device 41 can be a reversible proton exchange membrane fuel cell, a reversible alkaline fuel cell, a reversible phosphoric acid fuel cell, a reversible carbonate molten salt fuel cell, a solid oxide fuel cell, or any combination thereof.

The reversible fuel cell device 41 is connected to the pressure swing adsorption (PSA) oxygen generator 42, a hydrogen storing unit 43 and an oxygen storing unit 44. The pressure swing adsorption (PSA) oxygen generator 42 is used for generating oxygen. The reversible fuel cell device 41 can operate in a first mode (A) or a second mode (B). When the reversible fuel cell device 41 operates in the first mode (A), the reversible fuel cell device 41 receives the electrical power of the power source to electrolyze water in order to generate hydrogen (H₂), and stores the generated hydrogen in the hydrogen storing unit 43. When the reversible fuel cell device 41 operates in the second mode (B), the reversible fuel cell device 41 generates an electrical power by making the reaction of the oxygen generated from the PSA oxygen generator 42 or the oxygen storing unit 44 and the hydrogen provided by the hydrogen storing unit 43.

The reversible fuel cell device 41 can be connected to an external power source (not show in figures), such as solar power, an electricity grid system or other types of power source, to supply an electrical power to the electricity grid system or get an electrical power from the electricity grid system. For example, the reversible fuel cell device 41 (or the electrolysis device 41) is working in the electrolysis conditions, when the external power source is for off-electricity hours, the reversible fuel cell device 41 can operate in the first mode (A) and electrolyze water to generate hydrogen and oxygen, and converts the electrical power of the power source into hydrogen and stores the converted hydrogen to the hydrogen storing unit 43, and the oxygen generated by the reversible fuel cell device 41 can be stored in the oxygen storing unit 44. When the external power source is for peak electricity hours, the reversible fuel cell device 41 can operate in the second mode (B) and utilizes the electrical power generated by making the reaction of the oxygen and hydrogen, and then the reversible fuel cell device 41 supplies the generated electrical power to the external power source (like electricity grid system). It's worth mentioning the oxygen provided by the pressure swing adsorption (PSA) oxygen generator 42 can enhance the power generation efficiency of the reversible fuel cell device 41 when the reversible fuel cell device 41 generates electrical power (as the previous exemplary embodiment described). Therefore, compared to conventional fuel cells, the instant embodiment of the fuel cell power generation system 4 can obviously generate more electrical power when it generates electrical power.

According to the exemplary embodiment of the instant disclosure, the fuel cell power generation system uses the oxygen generated from the PSA oxygen generator to replace air, in order to effectively improve the output power of the fuel cell. Meanwhile, the enhanced output power of the fuel cell is greater than the power consumed by the PSA oxygen generator. In this way, the power generation efficiency of the fuel cell power generation system can be enhanced. Additionally, the reversible fuel cell can operate in two modes, one mode is for off-electricity hours to generate hydrogen (and oxygen) and the other mode is for peak electricity hours to generate electrical power.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the instant disclosure pertains without departing from its spirit and scope. Accordingly, the scope of the instant disclosure is defined by the appended claims rather than the foregoing description and the exemplary embodiments described therein.

What is claimed is:

1. A method for generating extra power on fuel cell power generation system in using oxygen enriched gas, the method comprising:
coupling an oxygen separator to a cathode of a fuel cell device, and a hydrogen generation apparatus to an anode of the fuel cell device respectively, to form a first fuel cell power generation system, wherein the first fuel cell power generation system comprises the fuel cell device, the oxygen separator, the hydrogen generation apparatus and an air compressor connected to the oxygen separator;
generating hydrogen by the hydrogen generation apparatus;
generating compressed air by the air compressor, and sending the compressed air to the oxygen separator;
generating oxygen enriched gas by the oxygen separator from the compressed air received from the air compressor;
introducing the oxygen enriched gas generated by the oxygen separator into the cathode of the fuel cell device, and introducing the hydrogen generated by the hydrogen generation apparatus into the anode of the fuel cell device, to generate electrical power from the fuel cell device; and
powering the oxygen separator and the air compressor using a portion of the electrical power generated from the fuel cell device;
wherein the first fuel cell power generation system is configured to generate extra power comparing to a second fuel cell power generation system operated under same conditions as the first fuel cell power generation system without using the oxygen separator, the second fuel cell power generation system comprising the fuel cell device, the hydrogen generation apparatus and the air compressor coupled directly to the cathode of the fuel cell device, and using the hydrogen generated by the hydrogen generation apparatus and the compressed air generated by the air compressor for the anode and the cathode of the fuel cell device respectively to generate electrical power;
wherein the extra power is defined by a formula as follows:
$$Z = \frac{K \times G \times V \times ( 5 \times E \times F - 1 ) - X}{K \times G \times V - Y} \times 100 \%$$
wherein:
Z is a net extra power ratio of a net electrical power output difference between the first fuel cell power generation system and the second fuel cell power generation system to a second net electrical power output by the second fuel cell power generation system, wherein the net electrical power output difference is a difference between a first net electrical power output by the first fuel cell power generation system and the second net electrical power output by the second fuel cell power generation system;
K is a characteristic factor of the electrical power generated by categories of the fuel cell device of the first fuel cell power generation system and the second fuel cell power generation system, respectively;
E is a required volume of the oxygen enriched gas generated by the oxygen separator of the first fuel cell power generation system;
F is a performance increase factor of using the required volume of the oxygen enriched gas in the fuel cell device of the first fuel cell power generation system;
G is a required volume of air by the air compressor of the first fuel cell power generation system, and by the air compressor of the second fuel cell power generation system, respectively;
V is an operating voltage by the fuel cell device of the first fuel cell power generation system, and by the fuel cell device of the second fuel cell power generation system, respectively;
X is the portion of the electrical power generated by the fuel cell device used by the oxygen separator of the first fuel cell power generation system; and
Y is the portion of the electrical power used by the air compressor of the first fuel cell power generation system, and by the air compressor of the second fuel cell power generation system;
wherein Z is proportional to a fuel cell number of the fuel cell device in a series connection.

2. The method according to claim 1, wherein all of the electrical power consumed by the oxygen separator and the air compressor of the first fuel cell power generation system are provided by the electrical power generated by the fuel cell device of the first fuel cell power generation system.

3. The method according to claim 2, wherein Z is greater than 20%.

4. The method according to claim 1, wherein the oxygen separator is an adsorption gas apparatus, a cryogenic separation apparatus, a membrane separation apparatus, an chemical process apparatus, or any combination thereof.

5. The method according to claim 1, wherein the hydrogen generation apparatus further comprises the hydrogen storing unit, and the oxygen separator further comprises an oxygen storing unit.

6. The method according to claim 1, wherein the hydrogen generation apparatus is a hydrogen storage tank, an electrolysis device, a reformer device, or any combination thereof.

7. The method according to claim 6, wherein the reformer device catalyzes the hydrogen carbon species to generate the hydrogen.

8. The method according to claim 6, wherein the electrolysis device is powered by solar power to electrolyze water to generate the hydrogen.

9. The method according to claim 6, wherein the electrolysis device utilizes proton exchange membrane water electrolysis, alkaline electrolysis, phosphoric acid electrolysis, carbonate molten salt electrolysis, solid oxide electrolysis, or any combination thereof.

10. The method according to claim 1, wherein the fuel cell device and the hydrogen generation apparatus are implemented by a reversible fuel cell device.

11. The method according to claim 10, wherein the reversible fuel cell device is configured to operate in a first mode or a second mode, wherein:
when the reversible fuel cell device operates in the first mode, the reversible fuel cell device receives electrical power to electrolyze water for generating the hydrogen, and
when the reversible fuel cell device operates in the second mode, the reversible fuel cell device utilizes the hydrogen generated in the first mode and the oxygen enriched gas generated by the oxygen separator to generate the electrical power.

12. The method according to claim 11, wherein when the reversible fuel cell device operates in the first mode, the hydrogen generated is stored in a hydrogen storing unit.

13. The method according to claim 12, wherein when the reversible fuel cell device operates in the second mode, the reversible fuel cell device utilizes the hydrogen from the hydrogen storing unit to generate the electrical power.

14. The method according to claim 10, wherein the reversible fuel cell device is a reversible proton exchange membrane fuel cell device, an reversible alkaline fuel cell device, a reversible phosphoric acid fuel cell device, a reversible carbonate molten salt fuel cell device, a reversible solid oxide fuel cell device, or any combination thereof.

15. The method according to claim 1, wherein the fuel cell device is a proton exchange membrane fuel cell device, a direct methanol fuel cell device, an alkaline fuel cell device, a phosphoric acid fuel cell device, a carbonate molten salt fuel cell device, a solid oxide fuel cell device, or any combination thereof.
